(19) United States
(12) Patent Application Publication
(10) Pub. No.: US 2015/0188411 A1
(43) Pub. Date: Jul. 2, 2015

(54) DC/DC CONVERTERS AND OUTPUT CIRCUITS THEREOF

(71) Applicant: O2Micro Inc, Santa Clara, CA (US)

(72) Inventors: Laszlo LIPCSEI, Campbell, CA (US); Catalin POPOVICI, San Jose (RO); Sorin HORNET, Milpitas (RO); Alin GHERGHESCU, San Jose (RO)

(73) Assignee: O2Micro Inc, Santa Clara, CA (US)

(21) Appl. No.: 14/141,994

(22) Filed: Dec. 27, 2013

(51) Int. Cl. H02M 1/34; H02M 3/335; H02M 7/06

(52) U.S. Cl. CPC H02M 1/34; H02M 7/066; H02M 3/335

(57) ABSTRACT

In an output circuit, a rectifying circuit outputs a rectified signal at an output node. The rectified signal has a rising edge and a falling edge. An energy storage component is coupled to the output node. A controllable path, coupled to the energy storage component, can be turned on if a voltage drop of the controllable path is greater than a voltage threshold. The controllable path can also be turned on in response to a turn-on signal. A control circuit, coupled to the controllable path, generates the turn-on signal subsequent to the rising edge of the rectified signal, and terminates the turn-on signal when a predetermined time interval expires subsequent to the generating of the turn-on signal and prior to the falling edge of the rectified signal.

### BACKGROUND

FIG. 1 depicts a circuit diagram of a conventional transformer-based direct-current to direct-current (DC/DC) converter 100. The DC/DC converter 100 includes switching circuitry 102, a transformer T1, and a rectifying circuit 104. The switching circuitry 102 controls a connection status between the primary winding P1 of the transformer T1 and a power supply terminal VIN, therefore to control energy transfer from the primary winding P1 to the secondary winding 51. The rectifying circuit 104 rectifies the voltage across the secondary winding S1 to generate a rectified signal at a switching node LX.

The secondary winding S1 includes parasitic capacitance C_{PARA} and inductance L_{LEAK}, which constitute a resonant circuit. The resonant circuit causes voltage ringing on the secondary winding, and the amplitude of the voltage ringing can be relatively high if the power on the primary winding P1 changes abruptly, e.g., when the switching circuitry 102 connects the primary winding P1 to the power supply terminal VIN. The high voltage ringing can pass through the rectifying circuit 104 to the switching node LX. Thus, as shown in FIG. 2, high voltage ringing 202 exits at the switching node LX in each switching cycle of the DC/DC converter 100, which may cause damage to the rectifying circuit 104 and/or associated circuits such as the output inductor L₁, the output capacitor C_{OUT}, and a load (not shown) coupled to the output terminal VOUT.

A conventional solution to solve this problem includes using a passive snubber, e.g., having resistive and capacitive elements, to shunt or filter the high voltage ringing to ground. However, the passive snubber may dissipate a relatively high amount of power and reduce the power conversion efficiency of the DC/DC converter 100. Thus, solutions that address these shortcomings would be beneficial.

### SUMMARY

In one embodiment, in an output circuit, a rectifying circuit is configured to output a rectified signal at an output node. The rectified signal has a rising edge and a falling edge. An energy storage component is coupled to the output node. A controllable path coupled to the energy storage component is configured to be turned on if a voltage drop of the controllable path is greater than a voltage threshold. The controllable path is also configured to be turned on in response to a turn-on signal. A control circuit, coupled to the controllable path, is configured to generate the turn-on signal subsequent to the rising edge of the rectified signal, and terminate the turn-on signal when a predetermined time interval expires subsequent to the generating of the turn-on signal and prior to the falling edge of the rectified signal.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 depicts a circuit diagram of a conventional transformer-based DC/DC converter.

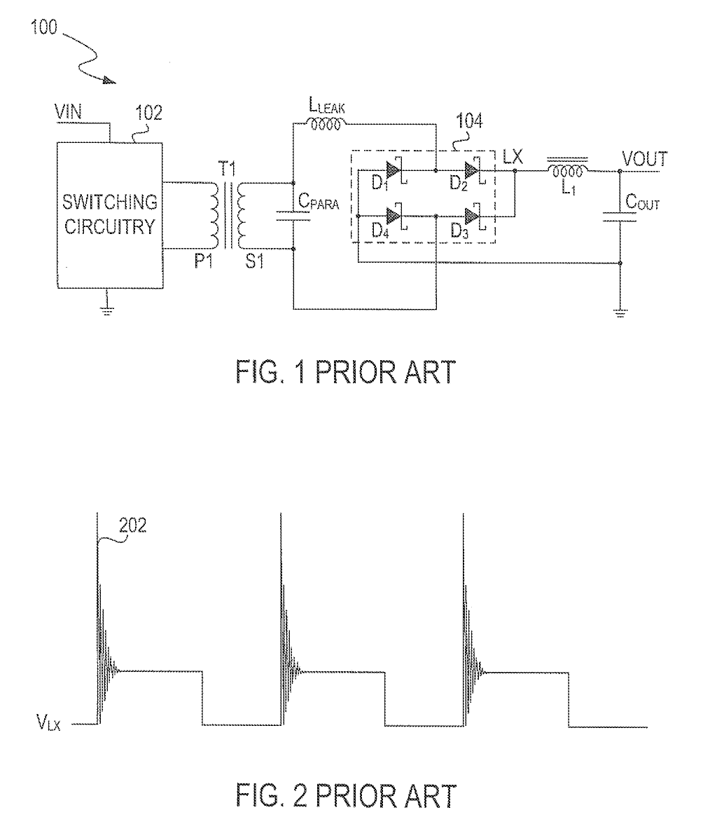

FIG. 2 depicts high voltage ringing at the output side of the DC/DC converter in FIG. 1.

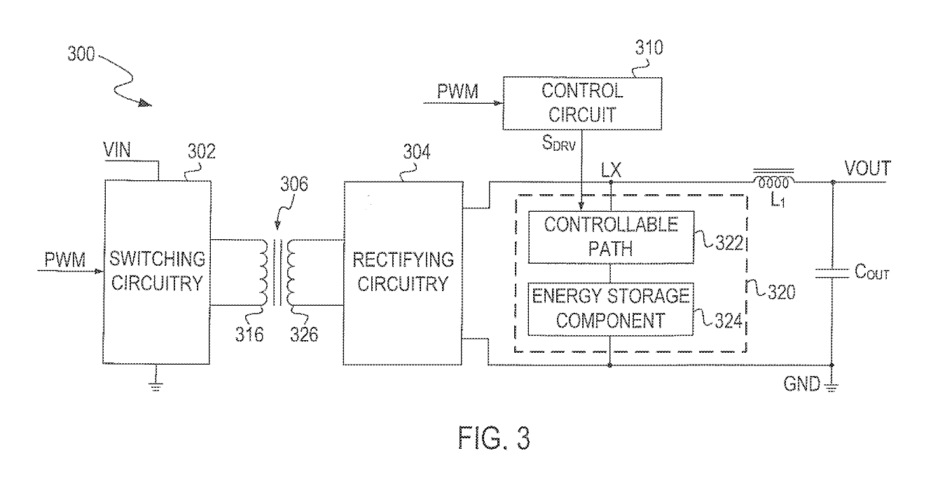

FIG. 3 depicts a block diagram of an example of a DC/DC converter, in an embodiment according to the present invention.

FIG. 4A, FIG. 4B, and FIG. 4C depict circuit diagrams of examples of an active snubber in a DC/DC converter, in embodiments according to the present invention.

FIG. 5 depicts examples of waveforms for signals associated with a DC/DC converter, in an embodiment according to the present invention.

FIG. 6A depicts a block diagram of an example of a control circuit in a DC/DC converter, in an embodiment according to the present invention.

FIG. 6B depicts a circuit diagram of an example of a control circuit in a DC/DC converter, in an embodiment according to the present invention.

FIG. 7 depicts examples of waveforms for signals associated with a control circuit, in an embodiment according to the present invention.

FIG. 8A, FIG. 8B, FIG. 8C, and FIG. 8D depict circuit diagrams of examples of DC/DC converters, in embodiments according to the present invention.

FIG. 9 depicts a flowchart of examples of operations performed by an output circuit in a DC/DC converter, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments according to the present invention provide solutions to suppress high voltage ringing at the output side of a DC/DC converter. The solution in an embodiment according to the present invention includes using an active snubber to absorb and store energy transformed from the high voltage ringing to reduce the amplitude of the voltage ringing, so as to protect the DC/DC converter from the above mentioned damages in the conventional DC/DC converter. The active snubber can also release the stored energy back to the DC/DC converter to reduce power losses. Thus, compared with the conventional solution using a passive snubber, an active snubber according to embodiments according to the present invention dissipates less power, and increases the power conversion efficiency of the DC/DC converter.

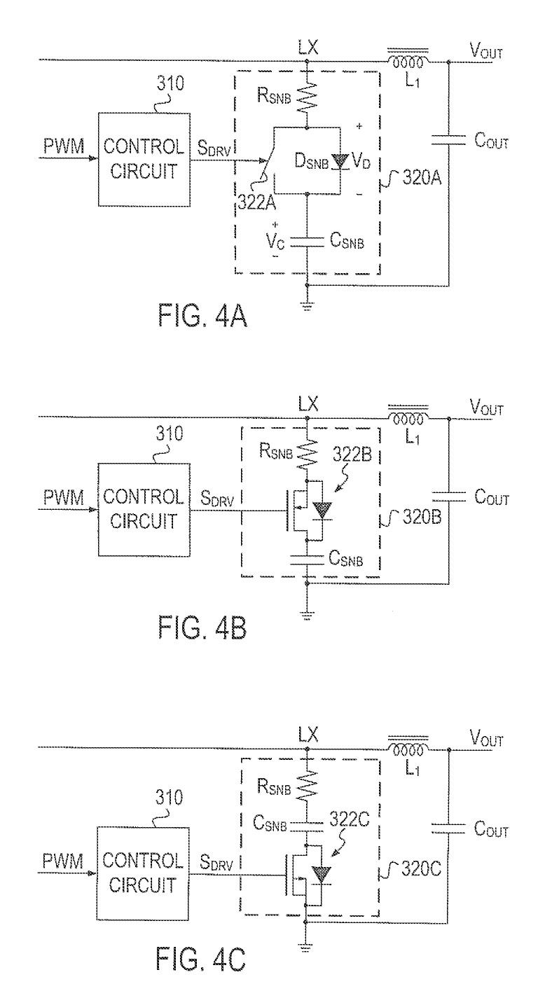

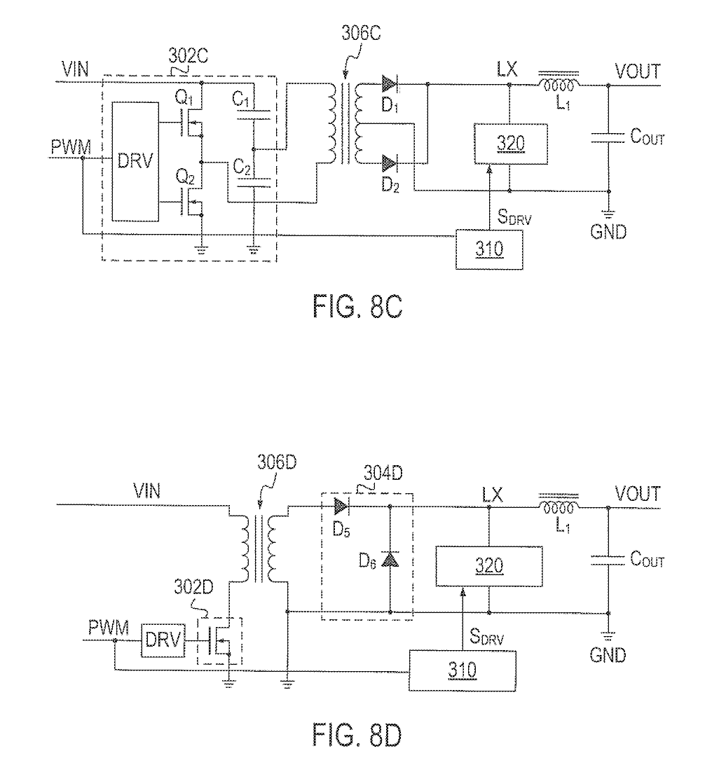

FIG. 3 depicts a block diagram of an example of a DC/DC converter 300, in an embodiment according to the present invention. The DC/DC converter 300 includes switching circuitry 302, a transformer 306, a rectifying circuit 304, an active snubber 320, and a control circuit 310. The switching circuitry 302, transformer 306, and rectifying circuit 304 can have various structures. Examples of the switching circuitry 302, transformer 306, and rectifying circuit 304 are depicted in FIG. 8A, FIG. 8B, FIG. 8C, and FIG. 8D. As shown in FIG. 3, the transformer 306 includes a primary winding 316 coupled to a power supply terminal VIN through the switching circuitry 302, and a secondary winding 326 coupled to the rectifying circuit 304. The rectifying circuit 304 is coupled to an output terminal VOUT of the DC/DC converter 300 via an output node LX (or a switching node LX) and an output inductor L1. The active snubber 320 is coupled between the output node LX and a reference terminal, e.g., a ground terminal GND of the DC/DC converter 300, and includes a controllable path 322 and an energy storage component 324 coupled in series.

In one embodiment, the switching circuitry 302 is controlled by a pulse width modulation (PWM) signal to selectively transfer input power from the power supply terminal VIN of the DC/DC converter 300 to the primary winding 316. The transformer 306 is in a first status when the switching circuitry 302 transfers the input power from the power supply terminal VIN to the transformer 306, and in a second status when the switching circuitry 302 terminates the transferring of the input power to the transformer 306. The PWM signal can be generated by a controller (not shown) according to an output voltage and/or output current of the DC/DC converter 300 so as to control the output voltage and/or output current to targeted levels. Generation of PWM signals in DC/DC converters and usage of PWM signals for controlling switching circuitry such as full-bridge or half-bridge circuitry in transformer-based DC/DC converters are well known in the art and therefore are not described in detail herein.

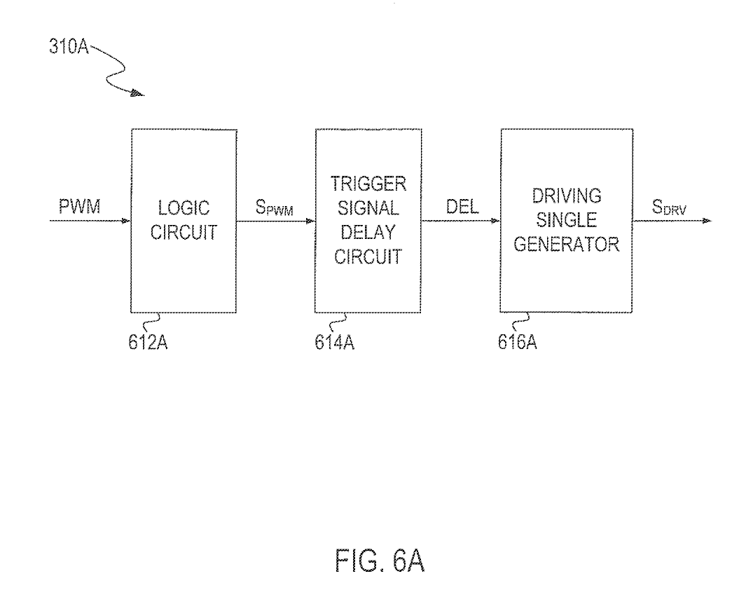

In one embodiment, when the transformer 306 is in the first status, the primary winding 316 receives input power from the power supply terminal VIN through the switching circuitry 302 to induce a varying magnetic field in the core of the transformer 306, and therefore an induced voltage is generated at the secondary winding 326 of the transformer 306. When the transformer 306 is in the second status, the primary winding 316 terminates receiving the input power, and the induced voltage can turn to a relatively small level, e.g., approximately zero volts. The induced voltage can be transferred to the output node LX through the rectifying circuit 304 to become a rectified signal V_{LX}, e.g., a square wave voltage V_{LX} shown in FIG. 5. In one embodiment, the rectifying circuit 304 outputs the rectified signal V_{LX} at the output node LX according to a status, e.g., the first status or the second status, of the transformer 306. By way of example, the rectified signal V_{LX}, e.g., a square wave voltage, has rising edges and falling edges. A rising edge of the rectified signal V_{LX} can be generated in response to an initiation of receiving the input power at the primary winding 316, and a falling edge of the rectified signal V_{LX} can be generated in response to a termination of receiving the input power at the primary winding 316.

In one embodiment, the secondary winding 326 includes parasitic capacitance C_{PARA} and inductance L_{LEAK} (not shown), which constitute a parasitic resonant circuit that may cause voltage ringing on the secondary winding 326. The induced voltage of the secondary winding 326 together with the voltage ringing may then be transferred to the output node LX. As shown in FIG. 3, the energy storage component 324 can be used to absorb and store energy transformed from the voltage ringing to reduce the amplitude of the voltage ringing, and can also be used to release or recuperate the stored energy back to the DC/DC converter 300 to reduce power losses. The control circuit 310 can generate a driving signal S_{DRV} to turn on or off the controllable path 322. Advantageously, high voltage ringing existing in the conventional DC/DC converter 100 can be suppressed in the DC/DC converter 300, and the power conversion efficiency of the DC/DC converter 300 can be enhanced compared with the conventional solution.

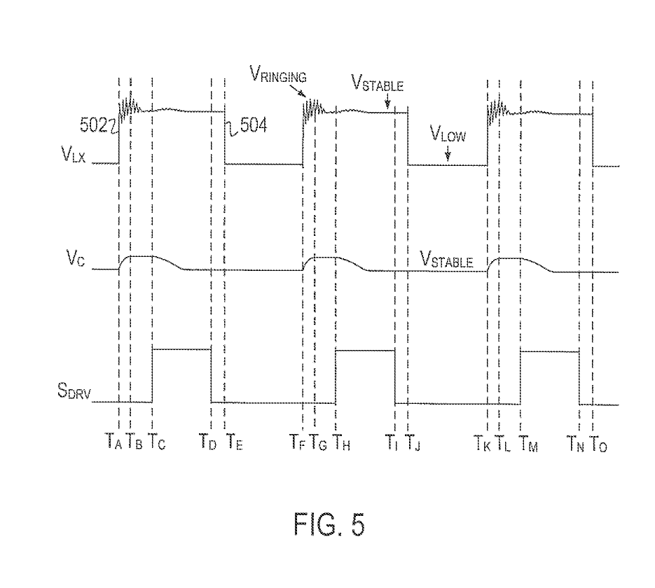

FIG. 4A, FIG. 4B, and FIG. 4C depict circuit diagrams of examples of the active snubber 320 in FIG. 3, in embodiments according to the present invention. Elements labeled the same as in FIG. 3 have similar functions. FIG. 4A, FIG. 4B, and FIG. 4C are described in combination with FIG. 3.

In the active snubber 320A of FIG. 3, the aforementioned energy storage component 324 includes a snubber capacitor C_{SNB}, the aforementioned controllable path 322 includes a snubber diode D_{SNB} and a switch 322A coupled in parallel with the snubber diode D_{SNB}, and a current limiting resistor R_{SNB} is coupled in series to the snubber capacitor C_{SNB} and the parallel-coupled switch 322A and snubber diode D_{SNB}. The snubber diode D_{SNB} has an anode coupled to the output node LX and a cathode coupled to a reference terminal such as the ground terminal GND of the DC/DC converter 300. The switch 322A has a controlled terminal coupled to the control circuit 310.

In one embodiment, the controllable path 322 including the switch 322A and snubber diode D_{SNB} can be turned on if a voltage drop V_{D} of the controllable path 322 is greater than a voltage threshold. The controllable path 322 can also be turned on in response to a turn-on signal from the control circuit 310. By way of example, if a voltage V_{D} across the snubber diode D_{SNB} is greater than a voltage threshold such as a forward biased voltage threshold V_{FWB} of the snubber diode D_{SNB}, then the snubber diode D_{SNB} is turned on, and so is the controllable path 322. Additionally, the control circuit 310 can set the driving signal S_{DRV} to a first level, e.g., logic high (or logic low), to turn on the switch 322A, or to a second level, e.g., logic low (or logic high), to turn off the switch 322A. The driving signal S_{DRV} at the first level can be referred to as a “turn-on signal.” When the switch 322A is turned on, the controllable path 322 is turned on. In other words, the control circuit 310 can generate a turn-on signal, e.g., a driving signal S_{DRV} at the first level, to turn on the controllable path 322, and can terminate the turn-on signal, e.g., by setting the driving signal S_{DRV} to the second level, to turn off the controllable path 322.

In one embodiment, when the transformer 306 is initiated to receive input power, the rectified signal V_{LX} generated at the output node LX includes a relatively stable level V_{STABLE} (e.g., determined by a voltage across the primary winding 316 and a turn ratio between the primary winding 316 and the secondary winding 326) and voltage ringing V_{RINGING} (e.g., caused by the aforementioned parasitic resonant circuit of the secondary winding 326) superimposed on the stable level V_{STABLE}. After a certain time interval, the voltage ringing V_{RINGING} can be attenuated to substantially zero, and the rectified signal V_{LX} can remain at the relatively stable level V_{STABLE}. In one embodiment, the voltage ringing V_{RINGING} superimposed on the stable level V_{STABLE} can cause the voltage V_{D} across the snubber diode D_{SNB} to be greater than the voltage threshold V_{FWB} to turn on the snubber diode D_{SNB}. Accordingly, the snubber capacitor C_{SNB} can be charged by the voltage ringing V_{RINGING}, through the snubber diode D_{SNB}, to absorb and store energy transformed from the voltage ringing V_{RINGING}. When the voltage ringing V_{RINGING} is attenuated to a certain level or when a capacitor voltage V_{C} of the snubber capacitor C_{SNB} increases to a certain level, the voltage V_{D} across the snubber diode D_{SNB} is less than the voltage threshold V_{FWB}, and the snubber diode D_{SNB} is turned off and so does the controllable path 322. After the certain time interval, the control circuit 310 can generate a turn-on signal to turn on the switch 322A (or the controllable path 322), and hence the snubber capacitor C_{SNB} can discharge to release energy to the output node LX through the switch 322A. In other words, in one embodiment, when the rectified signal V_{LX} causes the voltage V_{D} across the snubber diode D_{SNB} to be greater than the voltage threshold V_{FWB}, the snubber diode D_{SNB} is turned on. When the controllable path 322 is turned on by a voltage drop of the controllable path 322, e.g., the voltage V_{D} across the snubber diode D_{SNB}, that is greater than the voltage threshold V_{FWB}, the energy storage component 324 such as the snubber capacitor C_{SNB} stores energy from the output node LX. When the controllable path 322 is turned on by a turn-on signal from the control circuit 310, the energy storage component 324 releases energy to the output node LX.

In one embodiment, when the controllable path 322 is turned on by the turn-on signal from the control circuit 310, the snubber capacitor C_{SNB} can discharge to have the same voltage level of the output node LX, e.g., the stable level V_{STABLE}. Thus, when the controllable path 322 is turned off, the capacitor C_{SNB} can remain approximately at the stable level V_{STABLE}. Advantageously, if voltage ringing V_{RINGING} occurs at the output node LX, causing the rectified signal V_{LX} to be greater than the stable level V_{STABLE} plus the forward biased voltage threshold V_{FWB} of the snubber diode D_{SNB}, then the controllable path 322 is turned on so that the snubber capacitor C_{SNB} absorbs and suppresses the voltage ringing V_{RINGING}.

The arrangement of the current limiting resistor R_{SNB}, the controllable path 322 including the switch 322A and the snubber diode D_{SNB}, and the snubber capacitor C_{SNB} disclosed in FIG. 4A is for illustration purposes and is not intended to limit the invention. In other embodiments, the limiting resistor R_{SNB} can be coupled between the controllable path 322 and the snubber capacitor C_{SNB}, or between the snubber capacitor C_{SNB} and the ground terminal GND, etc. In yet other embodiments, the snubber capacitor C_{SNB} can be coupled between the output node LX and the limiting resistor R_{SNB}, or between the limiting resistor R_{SNB} and the controllable path 322, etc.

FIG. 4B and FIG. 40 depict circuit diagrams of other examples of the active snubber 320 in FIG. 3, in embodiments according to the present invention. In the active snubber 320B of FIG. 4B, the controllable path includes an N-channel metal oxide semiconductor field effect transistor (N-channel MOSFET) 322B controlled by a turn-on signal from the control circuit 310. The N-channel MOSFET 322B includes a body diode to act as the snubber diode D_{SNB} discussed in FIG. 4A. In the active snubber 3200 of FIG. 40, the controllable path includes a P-channel MOSFET 3220 controlled by a turn-on signal from the control circuit 310. The P-channel MOSFET 3220 includes a body diode to act as the snubber diode D_{SNB} discussed in FIG. 4A. Control of the MOSFET 322B and the MOSFET 3220 is similar to that of the switch 322A, and is not repetitively described herein.

Structures of the active snubbers 320A, 320B and 3200 in FIG. 4A, FIG. 4B, and FIG. 40 are examples of an active snubber 320 according to embodiments of the present invention, and are not intended to limit the invention. In other embodiments, the active snubber 320 can have other structures so that the active snubber 320 can automatically absorb voltage ringing when the amplitude of the voltage ringing is greater than a certain value, e.g., causing the snubber diode D_{SNB} to be turned on, and can release energy to the DC/DC converter 300 under control of, e.g., the control circuit 310.

As mentioned above, the rectified signal V_{LX} can be, for example, a square wave voltage V_{LX} shown in FIG. 5. The rectified signal V_{LX} can have a high level approximately equal to the aforementioned stable level V_{STABLE} when the transformer 306 receives input power, and can have a low level V_{LOW} approximately equal to a ground voltage, e.g., zero volts, at the ground terminal GND of the DC/DC converter 300 when the transformer 306 stops receiving the input power. In one embodiment, if the controllable path 322 is turned on when the rectified signal V_{LX} is at the low level V_{LOW}, e.g., approximately zero volts, then the snubber capacitor C_{SNB} may discharge to ground through the controllable path 322 and the current limiting resistor R_{SNB}, which causes power losses. Thus, in one embodiment, the control circuit 310 generates the turn-on signal (e.g., sets the driving signal S_{DRV} to the first level) subsequent to a rising edge of the rectified signal V_{LX}, and terminates the turn-on signal (e.g., sets the driving signal S_{DRV} to the second level) when a predetermined time interval T_{PRE} expires subsequent to the generating of the turn-on signal and prior to a falling edge of the rectified signal V_{LX}. In other words, in one embodiment, the control circuit 310 generates the turn-on signal subsequent to an occurrence of the aforementioned first status, e.g., the initiation of receiving input power at the transformer 306, and terminates the turn-on signal when the predetermined time interval T_{PRE} expires subsequent to the generating of the turn-on signal and prior to an occurrence of the aforementioned second status, e.g., the termination of receiving the input power at the transformer 306. Consequently, the power losses caused by the discharging to ground of the snubber capacitor C_{SNB} can be avoided, and energy stored in the snubber capacitor C_{SNB} can be released to the DC/DC converter 300 relatively efficiently. The generation and termination of the turn-on signal are described in combination with FIG. 5.

FIG. 5 depicts examples of waveforms for the rectified signal V_{LX}, the capacitor voltage V_{C}, and the driving signal S_{DRV}, in an embodiment according to the present invention. FIG. 5 is described in combination with FIG. 3, FIG. 4A, FIG. 4B, and FIG. 4C. In the example of FIG. 5, from time T_{A} to T_{E}, time T_{F} to T_{J}, etc., the transformer 306 is in the aforementioned first status and receives input power from the power supply terminal VIN, and therefore the rectified signal V_{LX} is at a high level, e.g., a stable level V_{STABLE} superimposed with voltage ringing V_{RINGING}. From time T_{E} to T_{F}, time Tⱼ to T_{K}, etc., the transformer 306 is in the aforementioned second status and has stopped receiving the input power, and therefore the rectified signal V_{LX} is at a low level V_{LOW}, e.g., approximately zero volts. From time T_{A} to T_{B}, time T_{F} to T_{G}, etc., the voltage ringing V_{RINGING} superimposed on the stable level V_{STABLE} can cause the snubber diode D_{SNB} to be turned on. Thus, the snubber capacitor C_{SNB} absorbs and suppresses the voltage ringing V_{RINGING}, and the capacitor voltage V_{C} increases. When the capacitor voltage V_{C} increases to a certain level, e.g., at time T_{B}, T_{G}, etc., the snubber diode D_{SNB} is turned off and the capacitor voltage V_{C} remains at a certain level. At time T_{C}, T_{H}, etc., which is subsequent to a rising edge 502 of the rectified signal V_{LX}, indicative of an occurrence of the first status of the transformer 306, the control circuit 310 can generate a turn-on signal, e.g., by setting the driving signal S_{DRV} to be logic high (or logic low), to turn on the controllable path 322, and therefore the snubber capacitor C_{SNB} discharge energy to the output node LX. The capacitor voltage V_{C} can decrease to have the same voltage level at the output node LX. At time T_{D}, T_{I}, etc., which is prior to a falling edge 504 of the rectified signal V_{LX}, indicative of an occurrence of the second status of the transformer 306, the control circuit 310 terminates the turn-on signal, e.g., by setting the driving signal S_{DRV} to be logic low (or logic high), to turn off the controllable path 322. Thus, when the rectified signal V_{LX} is at the low level V_{LOW}, the controllable path 322 can be ensured to be turned off.

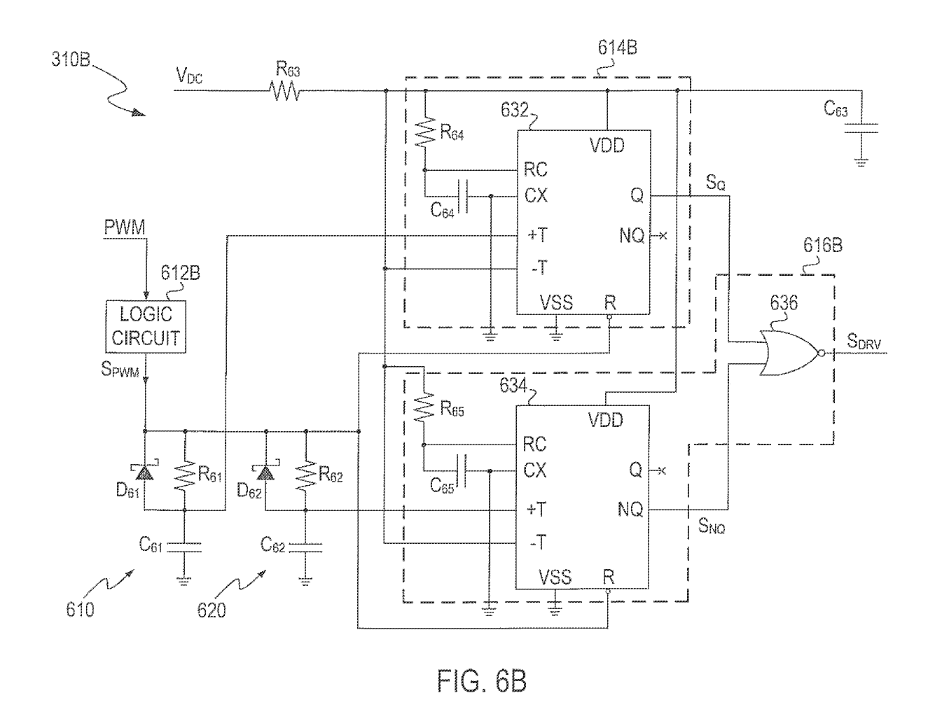

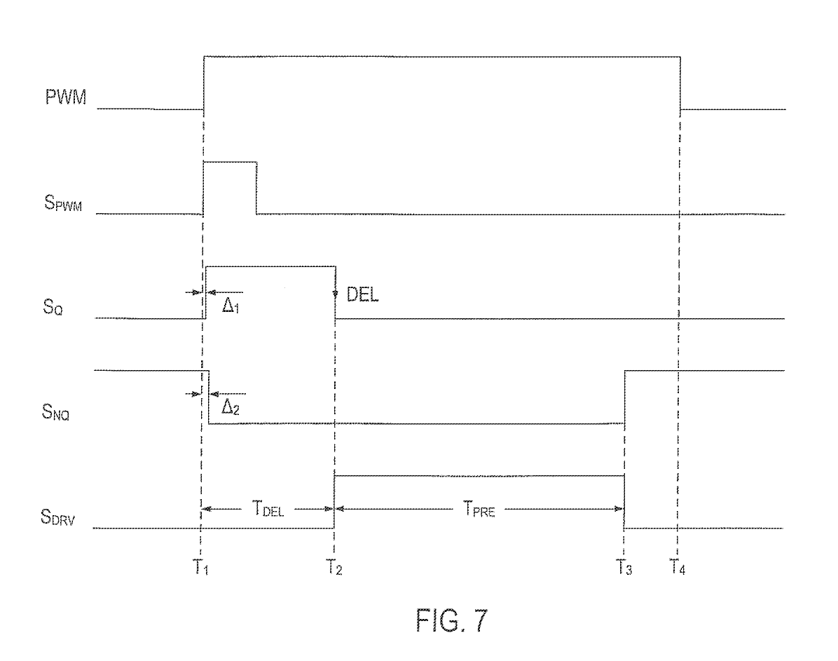

FIG. 6A depicts a block diagram of an example of the active snubber 320, in an embodiment according to the present invention. Elements labeled the same as in FIG. 3, FIG. 4A, FIG. 4B, and FIG. 4C have similar functions. FIG. 6A is described in combination with FIG. 3, FIG. 4A, FIG. 4B, FIG. 4C, and FIG. 5. As shown in FIG. 6A, the control circuit 310A can receive a PWM signal and generate the driving signal S_{DRV} based on the PWM signal. As mentioned above, the transformer 306 can receive input power through the switching circuitry 302 under the control of the PWM signal. In other words, the PWM signal can control the initiation and termination of receiving the input power at the transformer 306, e.g., the first and second statuses of the transformer 306. According to the PWM signal, the control circuit 310A can generate or terminate the aforementioned turn-on signal, e.g., by setting the driving signal S_{DRV} to a first level or a second level, to ensure that the controllable path 322 is turned off when the rectified signal V_{LX} is at a low level V_{LOW}.

In FIG. 6A, the control circuit 310A includes a logic circuit 612A, a trigger signal delay circuit 614A, and a driving signal generator 616A. Since the PWM signal can indicate the first status and second status of the transformer 306, the logic circuit 612A can generate an indication signal S_{PWM} indicating that a rising edge of the rectified signal V_{LX} is generated, e.g., the transformer 306 changes from the second status to the first status, by detecting a status change of the PWM signal. In one embodiment, the indication signal S_{PWM} includes a rising edge. In another embodiment, the indication signal S_{PWM} includes a falling edge. The trigger signal delay circuit 614A can detect the indication signal S_{PWM} (e.g., a rising edge or a falling edge) and generate a trigger signal DEL with a predetermined delay T_{DEL} (e.g., the time interval between times T_{A} and T_{C} shown in FIG. 5) in response to the indication signal S_{PWM}. The driving signal generator 616A can generate a turn-on signal in response to the trigger signal DEL, and terminate the turn-on signal when a predetermined time interval T_{PRE} (e.g., the time interval between times T_{C} and T_{D} shown in FIG. 5) expires. The predetermined delay T_{DEL} and the predetermined time interval T_{PRE} can be set to specified values such that the turn-on signal is generated subsequent to a rising edge of the rectified signal V_{LX}, e.g., an initiation of receiving input power at the transformer 306, and is terminated prior to a falling edge of the rectified signal V_{LX}, e.g., a termination of receiving the input power at the transformer 306. As a result, when the rectified signal V_{LX} is at the low level V_{LOW} the controllable path 322 can be ensured to be turned off.

FIG. 6B depicts a circuit diagram of an example of the control circuit 310, in an embodiment according to the present invention. Elements labeled the same as in FIG. 3, FIG. 4A, FIG. 4B, FIG. 40, and FIG. 6A have similar functions. FIG. 6B is described in combination with FIG. 3, FIG. 4A, FIG. 4B, FIG. 40, and FIG. 6A. As shown in FIG. 6B, the control circuit 310B includes a logic circuit 612B, a filter circuit 610, a filter circuit 620, a monostable circuit 632, a monostable circuit 634, and a NOR gate 636. The logic circuit 612B has functions similar to that of the logic circuit 612A in FIG. 6A.

In one embodiment, the monostable circuit 632 includes a reset terminal labeled “R,” a trigger terminal labeled “+T,” a non-inverting output terminal labeled “Q,” an inverting output terminal labeled “NQ,” and an input terminal labeled “RC.” The reset terminal R of the monostable circuit 632 is coupled to the logic circuit 612B and receives an indication signal S_{PWM} from the logic circuit 6128. The trigger terminal +T of the monostable circuit 632 is coupled to the filter circuit 610 and receives the indication signal S_{PWM} through the filter circuit 610. The non-inverting output terminal Q of the monostable circuit 632 is coupled to an input terminal of the NOR gate 636 and generates an output signal S_{Q} to the NOR gate 636. The inverting output terminal NQ of the monostable circuit 632 can be floating. In one embodiment, when the voltage level at the reset terminal R of the monostable circuit 632 is logic high, the monostable circuit 632 can set the output signal S_{Q} to logic high upon detecting a logic-high level at its trigger terminal +T. The input terminal RC of the monostable circuit 632 is coupled to an RC timing circuit, including a timing resistor R₆₄ and a timing capacitor C₆₄, that controls the time T_{SQ} during which the output signal S_{Q} is logic high (hereinafter, first duration T_{SQ}). When the first duration T_{SQ} expires, the monostable circuit 632 sets the output signal S_{Q} to logic low.

Similarly, in one embodiment, the monostable circuit 634 includes a reset terminal labeled “R,” a trigger terminal labeled “+T,” a non-inverting output terminal labeled “Q,” an inverting output terminal labeled “NQ,” and an input terminal labeled “RC.” The reset terminal R of the monostable circuit 634 is coupled to the logic circuit 612B and receives the indication signal S_{PWM} from the logic circuit 612B. The trigger terminal +T of the monostable circuit 634 is coupled to the filter circuit 620 and receives the indication signal S_{PWM} through the filter circuit 620. The inverting output terminal NQ of the monostable circuit 634 is coupled to an input terminal of the NOR gate 636 and generates an output signal S_{NQ} to the NOR gate 636. The non-inverting output terminal Q of the monostable circuit 634 can be floating. In one embodiment, when the voltage level at the reset terminal R of the monostable circuit 634 is logic high, the monostable circuit 632 can set the output signal S_{NQ} to logic low upon detecting a logic-high level at its trigger terminal +T. The input terminal RC of the monostable circuit 634 is coupled to an RC timing circuit, including a timing resistor R₆₅ and a timing capacitor C₆₅, that controls the time T_{SNQ} during which the output signal S_{NQ} is logic low (hereinafter, second duration T_{SNQ}). When the second duration T_{SNQ} expires, the monostable circuit 634 sets the output signal S_{NQ} to logic high. In one embodiment, the second duration T_{SNQ} is greater than the first duration T_{SQ}.

In one embodiment, the filter circuit 610 can filter noise in the indication signal S_{PWM} and provide the indication signal S_{PWM} to the trigger terminal +T of the monostable circuit 632 with a preset delay Δ1. The preset delay Δ1 is determined by resistance R₆₁ and capacitance C₆₁ in the filter circuit 610 and, compared with the first duration T_{SQ} of the monostable circuit 632, the preset delay Δ1 is relatively small and can be neglected. Similarly, the filter circuit 620 can filter noise in the indication signal S_{PWM} and provide the indication signal S_{PWM} to the trigger terminal +T of the monostable circuit 634 with a preset delay Δ2. The preset delay Δ2 is determined by resistance R₆₂ and capacitance C₆₂ in the filter circuit 620 and, compared with the second duration T_{SNQ} of the monostable circuit 634, the preset delay Δ2 is relatively small and can be neglected.

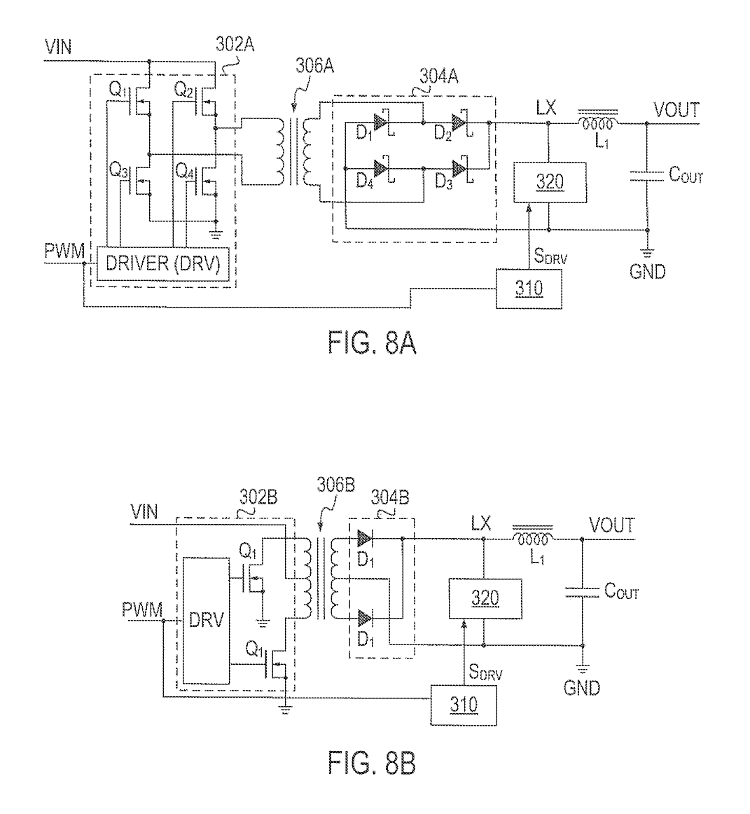

In one embodiment, the monostable circuit 632 can be used as a trigger signal delay circuit 614B similar to the above mentioned trigger signal delay circuit 614A, and the combined circuit of the monostable circuit 634 and the NOR gate 636 can be used as a driving signal generator 6168 similar to the above mentioned driving signal generator 616A. Operations of the trigger signal delay circuit 614B and the driving signal generator 616B are described in combination with FIG. 7.

FIG. 7 depicts examples of waveforms for the PWM signal, the indication signal S_{PWM}, the output signal S_{Q}, the output signal S_{NQ}, and the driving signal S_{DRV}, in an embodiment according to the present invention. In the example of FIG. 7, the transformer 306 receives input power when the PWM signal is logic high, and stops receiving input power when the PWM signal turns to logic low. The controllable path 322 is turned on when the driving signal S_{DRV} is logic high, and is turned off when the driving signal S_{DRV} is logic low. At time T_{I}, an indication signal S_{PWM}, e.g., a pulse, is generated. Accordingly, the output signal S_{Q} from the monostable circuit 632 turns to logic high, the output signal S_{NQ} from the monostable circuit 634 turns to logic low, and therefore the driving signal S_{DRV} output from the NOR gate 636 is at logic low. When the first duration T_{SQ} of the monostable circuit 632 expires, e.g., at time T₂, the output signal S_{Q} turns to logic low. Accordingly, the driving signal S_{DRV} output from the NOR gate 636 turns to logic high. Thus, in one such embodiment, the aforementioned predetermined delay T_{DEL} includes the first duration T_{SQ} of the monostable circuit 632, and the aforementioned trigger signal DEL includes a falling edge of the output signal S_{Q}. Additionally, when the second duration T_{SNQ} of the monostable circuit 634 expires, e.g., at time T₃, the output signal S_{NQ} turns to logic high. Accordingly, the driving signal S_{DRV} output from the NOR gate 636 turns to logic low. Thus, in one such embodiment, the aforementioned predetermined time interval T_{PRE} during which the driving signal S_{DRV} is at the first level, e.g., the turn-on signal is active, includes the second duration T_{SNQ} of the monostable circuit 634 minus the first duration T_{SQ} of the monostable circuit 632. Advantageously, the first duration T_{SQ} and the second duration T_{SNQ} can be set to specified values (e.g., by choosing the timing resistor R₆₄, capacitor C₆₄, resistor R₆₅, and capacitor C₆₅) to ensure that the controllable path 322 is turned off when the transformer 306 has stopped receiving input power.

Additionally, as mentioned above, the filter circuit 610 and the filter circuit 620 can cause delays Δ1 and Δ2 which are negligible compared with the first duration T_{SQ} and the second duration T_{SNQ}. In one embodiment, the delay Δ2 is set to be greater than the delay Δ1, e.g., by choosing the resistance R₆₁, capacitance C₆₁, resistance R₆₂, and capacitance C₆₂, to avoid a voltage spike in the driving signal S_{DRV}, so as to protect the controllable path 322.

FIG. 8A, FIG. 8B, FIG. 80, and FIG. 8D depict circuit diagrams of examples of the DC/DC converter 300, in embodiments according to the present invention. Elements labeled the same as in FIG. 3, FIG. 4A, FIG. 4B, FIG. 4C, FIG. 6A, and FIG. 6B have similar functions. As shown in FIG. 8A, FIG. 8B, FIG. 8C, and FIG. 8D, the switching circuitry 302 in FIG. 3 can include full-bridge switching circuit 302A, half-bridge switching circuit 302B, half-bridge switching circuit 3020, an input switch 302D, or the like. The transformer 306 in FIG. 3 can include a single primary winding and a signal secondary winding shown in the transformer 306A (or 306D), a center-tapped primary winding and a center-tapped secondary winding shown in the transformer 306B, a single primary winding and a center-tapped secondary winding shown in the transformer 3060, or the like. The rectifying circuit 304 in FIG. 3 can include a full-bridge rectifying circuit 304A, a half-bridge rectifying circuit 304B (or 304C), a half-bridge rectifying circuit 304D, or the like. FIG. 8A, FIG. 8B, FIG. 8C, and FIG. 8D illustrate examples of the DC/DC converter 300 and are not intended to limit the invention. In other embodiments, the DC/DC converter 300 can have other structures in which an active snubber according to the present invention is applicable.

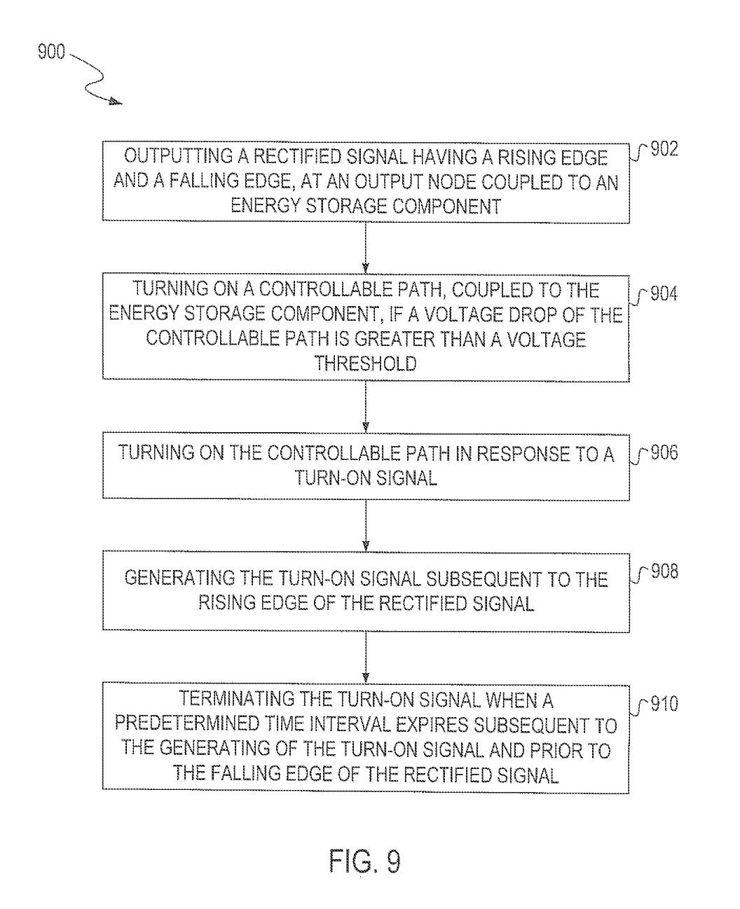

FIG. 9 depicts a flowchart of examples of operations performed by an output circuit in a DC/DC converter, e.g., the combined circuit of the rectifying circuit 304, the control circuit 310, and the active snubber 320 of the DC/DC converter 300 in FIG. 3, in an embodiment according to the present invention. FIG. 9 is described in combination with FIG. 3, FIG. 4A, FIG. 4B, FIG. 4C, FIG. 5, FIG. 6A, FIG. 6B, FIG. 7, FIG. 8A, FIG. 8B, FIG. 8C, and FIG. 8D.

In the example of FIG. 9, at step 902, the rectifying circuit 304 outputs a rectified signal V_{LX} at an output node LX coupled to an energy storage component, e.g., the snubber capacitor C_{SNB}. The rectified signal V_{LX}, e.g., a square wave voltage V_{LX} shown in FIG. 5, has rising edges and falling edges.

At step 904, the controllable path 322 coupled in series to the energy storage component, e.g., the snubber capacitor C_{SNB}, is turned on if a voltage drop V_{D} of the controllable path 322, e.g., a voltage across the snubber diode D_{SNB}, is greater than a voltage threshold, e.g., a forward biased voltage threshold V_{FWB} of the snubber diode D_{SNB}.

At step 906, the controllable path 322 is turned on in response to a turn-on signal from the control circuit 310.

At step 908, the control circuit 310 generates the turn-on signal, e.g., by setting the driving signal S_{DRV} to a first level, subsequent to the rising edge of the rectified signal V_{LX}.

At step 910, the control circuit 310 terminates the turn-on signal, e.g., by setting the driving signal S_{DRV} to a second level, when a predetermined time interval T_{PRE} expires subsequent to the generating of the turn-on signal and prior to the falling edge of the rectified signal V_{LX}.

In summary, in embodiments according to the present invention, voltage ringing at the output side of a DC/DC converter can be suppressed by an active snubber. The active snubber includes a controllable path, e.g., including a diode, that can be automatically turned on when the amplitude of the voltage ringing is greater than a certain level. The active snubber also includes an energy storage component, e.g., a capacitor, to absorb and store energy transformed from the voltage ringing when the controllable path, e.g., the diode, is turned on. Additionally, the stored energy can be released from the energy storage component to the DC/DC converter under control of a control circuit. As a result, voltage ringing at the output side of the DC/DC converter is suppressed, and the power conversion efficiency of the DC/DC converter is enhanced.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An output circuit comprising:
a rectifying circuit configured to output a rectified signal at an output node, said rectified signal comprising a rising edge and a falling edge;
an energy storage component coupled to said output node;
a controllable path, coupled to said energy storage component, configured to be turned on if a voltage drop of said controllable path is greater than a voltage threshold, and configured to be turned on in response to a turn-on signal; and
a control circuit, coupled to said controllable path, configured to generate said turn-on signal subsequent to said rising edge of said rectified signal, and configured to terminate said turn-on signal when a predetermined time interval expires subsequent to the generating of said turn-on signal and prior to said falling edge of said rectified signal.

2. The output circuit as claimed in claim 1, wherein said rectifying circuit is configured to control said rectified signal to be indicative of a status of a transformer having a secondary winding coupled to said rectifying circuit, and wherein said rising edge of said rectified signal is generated in response to an initiation of receiving input power at a primary winding of said transformer, and said falling edge of said rectified signal is generated in response to a termination of said receiving input power at said primary winding.

3. The output circuit as claimed in claim 2, wherein said control circuit is configured to receive a pulse width modulation (PWM) signal that controls said initiation and termination of said receiving input power, and configured to generate or terminate said turn-on signal according to said PWM signal.

4. The output circuit as claimed in claim 1, wherein said energy storage component comprises a capacitor.

5. The output circuit as claimed in claim 1, wherein said energy storage component stores energy from said output node when said controllable path is turned on by said voltage drop, and said energy storage component releases energy to said output node when said controllable path is turned on by said turn-on signal.

6. The output circuit as claimed in claim 1, wherein said controllable path comprises a diode having an anode coupled to said output node and a cathode coupled to a reference terminal, and said diode is turned on when said rectified signal causes a voltage across said diode to be greater than said voltage threshold.

7. The output circuit as claimed in claim 6, wherein said controllable path further comprises a switch coupled in parallel with said diode and controlled by said turn-on signal.

8. The output circuit as claimed in claim 6, wherein said controllable path comprises a metal oxide semiconductor field effect transistor (MOSFET) controlled by said turn-on signal, and said MOSFET comprises said diode.

9. The output circuit as claimed in claim 1, wherein said control circuit comprises:
a delay circuit configured to detect an indication signal indicating that said rising edge of said rectified signal is generated, and configured to generate a trigger signal with a predetermined delay in response to said indication signal; and
a signal generator, coupled to said delay circuit, configured to generate said turn-on signal in response to said trigger signal and to terminate said turn-on signal when said predetermined time interval expires.

10. A method comprising:
outputting a rectified signal comprising a rising edge and a falling edge, at an output node coupled to an energy storage component;
turning on a controllable path, coupled to said energy storage component, if a voltage drop of said controllable path is greater than a voltage threshold;
turning on said controllable path in response to a turn-on signal;
generating said turn-on signal subsequent to said rising edge of said rectified signal; and
terminating said turn-on signal when a predetermined time interval expires subsequent to said generating of said turn-on signal and prior to said falling edge of said rectified signal.

11. The method as claimed in claim 10, further comprising:
receiving input power at a transformer;
generating said rising edge of said rectified signal in response to an initiation of said receiving said input power; and
generating said falling edge of said rectified signal in response to a termination of said receiving said input power.

12. The method as claimed in claim 10, further comprising:
storing energy from said output node to said energy storage component when said controllable path is turned on by said voltage drop; and
releasing energy from said energy storage component to said output node when said controllable path is turned on by said turn-on signal.

13. The method as claimed in claim 10, wherein said turning on said controllable path comprises:
turning on a diode in said controllable path when said rectified signal causes a voltage across said diode to be greater than said voltage threshold, said diode having an anode coupled to said output node and a cathode coupled to a reference terminal,

14. The method as claimed in claim 10, further comprising:
detecting an indication signal indicating that said rising edge of said rectified signal is generated;
generating a trigger signal with a predetermined delay in response to said indication signal;
generating said turn-on signal in response to said trigger signal; and
terminating said turn-on signal when said predetermined time interval expires.

15. A DC/DC converter comprising:
a transformer comprising a first status and a second status;
a rectifying circuit coupled to said transformer and configured to output a rectified signal, at an output node, according to a status of said transformer;
an energy storage component coupled to said output node;
a controllable path, coupled to said energy storage component, configured to be turned on if a voltage drop of said controllable path is greater than a voltage threshold, and configured to be turned on in response to a turn-on signal; and
a control circuit, coupled to said transformer, configured to generate said turn-on signal subsequent to an occurrence of said first status, and configured to terminate said turn-on signal when a predetermined time interval expires subsequent to the generating of said turn-on signal and prior to an occurrence of said second status.

16. The DC/DC converter as claimed in claim 15, further comprising switching circuitry configured to be controlled by a pulse width modulation (PWM) signal to selectively transfer input power to said transformer, and wherein said transformer is in said first status when said switching circuitry transfers said input power to said transformer, and in said second status when said switching circuitry terminates transferring said input power to said transformer.

17. The DC/DC converter as claimed in claim 16, wherein said control circuit is configured to generate and terminate said turn-on signal according to said PWM signal.

18. The DC/DC converter as claimed in claim 15, wherein said energy storage component stores energy from said output node when said controllable path is turned on by said voltage drop, and said energy storage component releases energy to said output node when said controllable path is turned on by said turn-on signal.

19. The DC/DC converter as claimed in claim 15, wherein said controllable path comprises a diode having an anode coupled to said output node and a cathode coupled to a reference terminal, and said diode is turned on when said rectified signal causes a voltage across said diode to be greater than said voltage threshold.

20. The DC/DC converter as claimed in claim 19, wherein said controllable path comprises a metal oxide semiconductor field effect transistor (MOSFET) controlled by said turn-on signal, and said MOSFET comprises said diode.

21. The DC/DC converter as claimed in claim 15, wherein said control circuit comprises:
a delay circuit configured to detect an indication signal indicating that said transformer changes from said second status to said first status, and configured to generate a trigger signal with a predetermined delay in response to said indication signal; and
a signal generator, coupled to said delay circuit, configured to generate said turn-on signal in response to said trigger signal, and to terminate said turn-on signal when said predetermined time interval expires.
